(19) United States
(12) Patent Application Publication
(10) Pub. No.: US 2025/0342119 A1
(43) Pub. Date: Nov. 6, 2025

(54) CACHE STORAGE SPACE MANAGING METHOD AND ELECTRONIC DEVICE USING THE CACHE STORAGE SPACE MANAGING METHOD

(71) Applicant: MEDIATEK INC., Hsinchu City (TW)

(72) Inventors: Wei-Shuo Chen, Hsinchu City (TW); Bing-Chang Shih, Hsinchu City (TW); You-Hong Sun, Hsinchu City (TW); Hsiu-Chieh Hung, Hsinchu City (TW); Chung-Ho Chang, Hsinchu City (TW); Cheng-Che Chen, Hsinchu City (TW); Hsien-Hsi Hsieh, Hsinchu City (TW); Min-Cheng Yen, Hsinchu City (TW); Cheng-Han Tsai, Hsinchu City (TW); Yin Chen, Hsinchu City (TW); Shih-Chin Lin, Hsinchu City (TW); Chih-Chun Chiu, Hsinchu City (TW)

(73) Assignee: MEDIATEK INC., Hsinchu City (TW)

(21) Appl. No.: 19/180,153

(22) Filed: Apr. 16, 2025

Related U.S. Application Data
(60) Provisional application No. 63/641,984, filed on May 3, 2024.
(60) Provisional application No. 63/698,076, filed on Sep. 24, 2024.

(51) Int. Cl. G06F 12/0802

(52) U.S. Cl. CPC G06F 12/0802

(57) ABSTRACT

A cache storage space managing method, applied to an electronic device comprising a target storage device and a cache storage device for storing information which is to be accessed by the target storage device. The cache storage space managing method comprises: executing an application installed in the electronic device to generate cache storage management hint; and allocating cache storage space of the cache storage device to at least one sub-device in the electronic device or identifying a priority of a cache portion to be discarded or reserved in the cache storage device, according to the cache storage management hint by an operating system of the electronic device.

### CROSS REFERENCE TO RELATED APPLICATIONS

This application claims the benefit of U.S. Provisional Application No. 63/641,984, filed on May 3, 2024. Further, this application claims the benefit of U.S. Provisional Application No. 63/698,076, filed on Sep. 24, 2024. The contents of these applications are incorporated herein by reference.

### BACKGROUND

The present application relates to a cache storage space managing method and an electronic device using the cache storage space managing method, and particularly relates to a cache storage space managing method which can dynamically allocates cache storage space of a cache storage device and an electronic device using the cache storage space managing method.

An electronic device may comprise a cache storage device (e.g., a cache memory), which can assist data access. Management of the cache storage space of the cache storage device is quite important, since different devices may need different cache storage space in different states. However, the management rule of the cache storage space is always fixed. Accordingly, the performance of the device may not be optimized since the operation speed thereof may be limited to insufficient cache storage space.

Accordingly, a new cache storage space managing method is needed.

### SUMMARY

One objective of the present application is to provide a cache storage space managing method which can allocate the cache storage space accordingly to real requirements in a simpler way.

Another objective of the present application is to provide an electronic device which can allocate the cache storage space accordingly to real requirements in a simpler way.

One embodiment of the present application provides a cache storage space managing method, applied to an electronic device comprising a target storage device and a cache storage device for storing information which is to be accessed by the target storage device. The cache storage space managing method comprises: executing an application installed in the electronic device to generate cache storage management hint; and allocating cache storage space of the cache storage device to at least one sub-device in the electronic device, according to the cache storage management hint by an operating system of the electronic device.

Another embodiment of the present application provides an electronic device comprising a target storage device, a cache storage device and a processing circuit. The cache storage device is configured to store information which is to be accessed by the target storage device. The processing circuit is configured to perform following steps: executing an application installed in the electronic device to generate cache storage management hint; and allocating cache storage space of the cache storage device to at least one sub-device in the electronic device, according to the cache storage management hint by an operating system of the electronic device.

In view of above-mentioned embodiments, the allocation policy may be dynamically changed corresponding to real requirements of the app in a simpler way.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an electronic device according to one embodiment of the present application.

FIG. 2 is a schematic diagram illustrating a cache storage space managing method according to one embodiment of the present application.

FIG. 3 and FIG. 4 are schematic diagrams illustrating different conditions of task processing of the application, according to embodiments of the present application.

FIG. 5 is a flow chart illustrating a cache storage space managing method according to one embodiment of the present application.

### DETAILED DESCRIPTION

Several embodiments are provided in following descriptions to explain the concept of the present invention. The method in following descriptions can be performed by programs stored in a non-transitory computer readable recording medium by a processing circuit. The non-transitory computer readable recording medium can be, for example, a hard disk, an optical disc or a memory. Additionally, the term “first”, “second”, “third” in following descriptions are only for the purpose of distinguishing different elements, and do not mean the sequence of the elements. For example, a first device and a second device only mean these devices can have the same structure but are different devices.

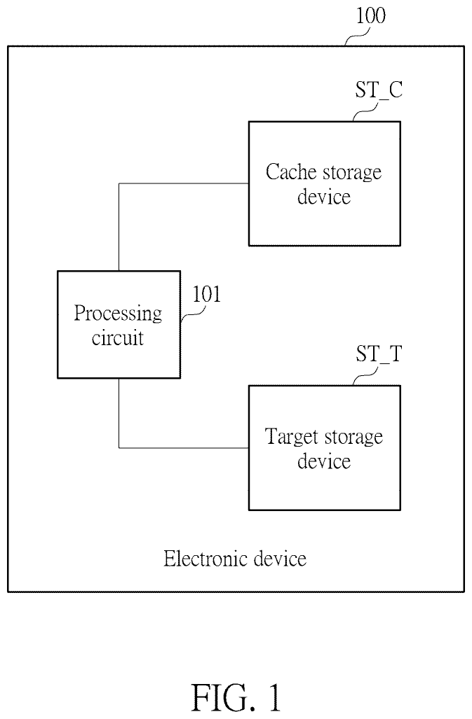

FIG. 1 is a block diagram illustrating an electronic device according to one embodiment of the present application. As shown in FIG. 1, the electronic device 100 comprises a processing circuit 101, a cache storage device ST_C and a target storage device ST_T. The cache storage device ST_C is configured to store information which is to be accessed by the target storage device ST_T. The information may comprise data, or comprise parameters for assist transmitting or receiving data, such as headers, addresses or CRC (cyclic redundancy check) codes. In one embodiment, an accessing speed of the cache storage device ST_C is higher than an accessing speed of the target storage device ST_T. For example, the cache storage device ST_C is a SRAM (static random-access memory) and the target storage device ST_T is a DRAM (dynamic random-access memory).

The processing circuit 101 is configured to control the operations of the electronic device 100. An application installed in the electronic device 100 is executed by the processing circuit 101 to generate cache storage management hint. Then the process circuit 101 uses the operating system (OS) of the electronic device 100 to allocate cache storage space of the cache storage device ST_C to at least one sub-device in the electronic device 100, according to the cache storage management hint. In one embodiment, the electronic device 100 is a mobile device such as a mobile phone or a tablet computer, and the OS is a mobile operating system. In such case, the OS may also be named as a platform of the mobile device. The sub-device may mean any component, module, circuit or device of the electronic device 100, such as a CPU (Central Processing Unit), a GPU (Graphics Processing Unit), or an APU (Accelerated Processing Unit).

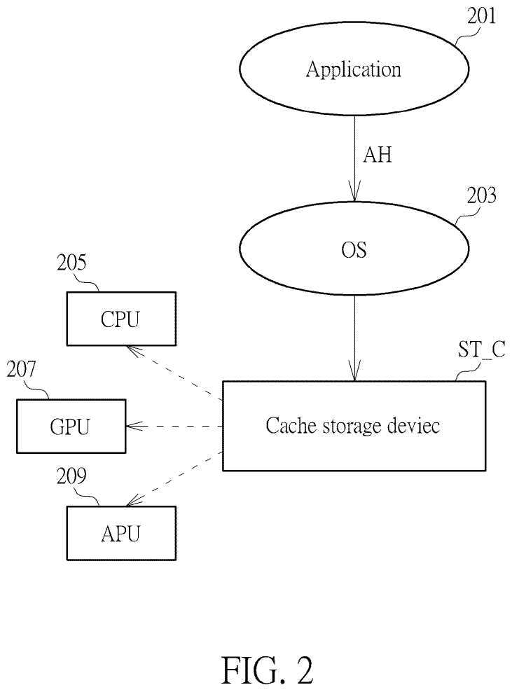

FIG. 2 is a schematic diagram illustrating a cache storage space managing method according to one embodiment of the present application. As shown in FIG. 2, the application 201 provides cache storage management hint AH to the OS 203, and then the OS 203 allocates the cache storage space of the cache storage device ST_C to the CPU 205, GPU 207 and the APU 209. In one embodiment, the OS 203 provides an API (application programming interface) to the application 201, thereby the application 201 can transmit the application hint AH to the OS 203 to control allocation of the cache storage device ST_C.

The cache storage management hint AH may comprise various types of hints. In one embodiment, the cache storage management hint AH comprises amount of cache storage space to be allocated to each one of the sub-device. For example, the cache storage management hint AH directly instruct the OS 203 to allocate 10 MB cache storage space to the CPU 205, 20 MB cache storage space to the GPU 207, and 15 MB cache storage space to the APU 209.

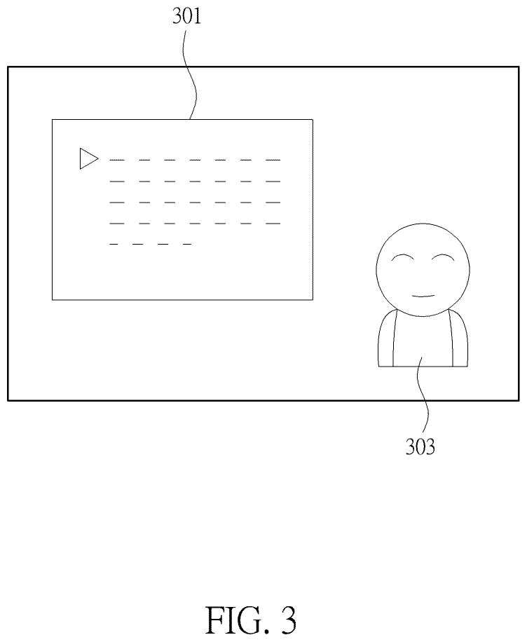

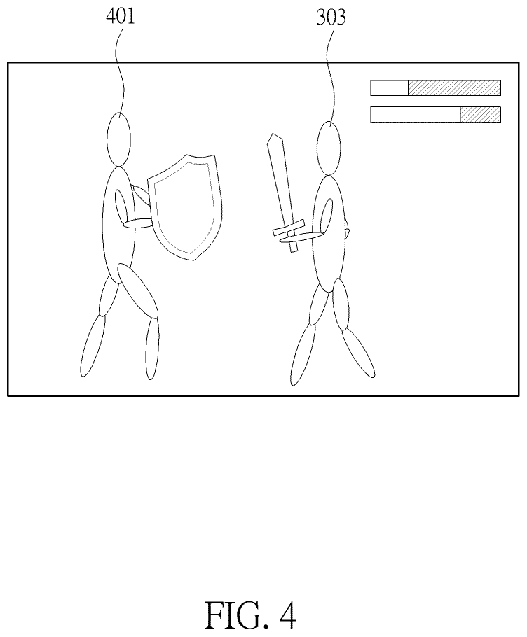

In another embodiment, the cache storage management hint AH comprises application usage scenarios or application behaviors of the application 201. In other words, the cache storage management hint AH comprises conditions of task processing of the application 203. FIG. 3 and FIG. 4 are schematic diagrams illustrating different conditions of task processing of the application, according to embodiments of the present application. In the embodiment of FIG. 3, the application 201 is a game application and is being executed to generate relatively static images. For example, the user who is playing the game has triggered a game character menu 301 and is checking the conditions of the game character 303. In such case, the GPU 207 draws game images of the application 201 at a lower frequency, and the contents of the game images are simple, thus less cache storage space is required. The application 201 may generate the cache storage management hint AH with such usage scenario, such application behaviors or such task processing conditions to the OS 203, thus the OS 203 correspondingly allocates less cache storage space to the GPU 207.

In the embodiment of FIG. 4, the application 201 is the same game application shown in FIG. 3 but is being executed to generate relatively dynamic images. For example, the user who is playing the game is controlling the game character 303 to fight with another game character 401. In such case, the GPU 207 draws game images of the application 201 at a higher frequency, and the contents of the game images are complicated since the images may contain a large amount of game effects, thus needs more cache storage space. The application 201 may generate the cache storage management hint AH with such usage scenario, such application behaviors or such task processing conditions to the OS 203, thus the OS 203 correspondingly allocates more cache storage space to the GPU 207.

The concept disclosed in the embodiments of FIG. 3 and FIG. 4 may be applied to other example rather than limited to the examples of FIG. 3 and FIG. 4. For example, in one embodiment, the application 201 is a media player application. In such case, more cache storage space is allocated to the CPU 205 since the processing of videos generally requires more cache storage space. In another embodiment, the application 201 is a document reader. In such case, less cache storage space is allocated to the CPU 205 since the processing of document generally requires less cache storage space. Such examples may also be regarded as: the cache storage management hint AH comprises the types of the applications.

In one embodiment, the OS 203 already uses an allocation policy and changes an allocation policy which is being used responding to the cache storage management hint AH. For more detail, the OS 203 uses a first allocation policy to allocate the cache storage space before receiving the cache storage management hint AH. The OS 203 generates a second allocation policy according to the cache storage management hint AH after receiving the cache storage management hint AH. Afterwards, the OS 203 uses the second allocation policy to allocate the cache storage space. The allocation policy may mean the cache storage space amount which is allocated to the sub-device. The allocation policy may also mean the rule of allocating cache storage space.

The hardware information of the sub-device, the cache storage device ST_C or the target storage device ST_T may be collected for determining the cache storage management hint AH or for determining the allocation policy. The hardware information may mean information related to the operation conditions, or information related to hardware performance. For example, the hardware information is the operation frequency of the CPU 205 or the GPU 207. For another example, the hardware information is the bandwidth of the cache storage device ST_C.

In one embodiment, the hardware information is collected by the application 201, and the application 201 generates the cache storage management hint AH according to the hardware information. In another embodiment, the hard information is collected by the OS 203. In such case, the cache storage space is allocated by the OS 203 according to the hardware information and the cache storage management hint AH.

Besides the above-mentioned embodiments, the cache storage device ST_C can be managed by other rules. For example, in one embodiment, determination is performed to determine which cache portion of the cache storage device ST_C is not used or will not be used (e.g., used by the application 201) to generate a first determination result. After that, the priority of the cache portion to be discarded is set according to the first determination result.

Specifically, the cache portion of the cache storage device ST_C is not used or will not be used is first discarded (i.e., has a high priority for discarding). The term “discard” mentioned here means the cache portion is released such that the storage space thereof can be allocated for other usages. By this way, the cache storage device ST_C can be effectively managed to reduce the number of accessing the target storage device ST_T.

In another embodiment, the usage frequency of data is determined to generate a second determination result. In such case, the priority of the cache portion is reserved for the data according to the second determination result. Specifically, the cache portion is first reserved for the data with a high usage frequency (i.e., the priority of the cache portion to be reserved is high). By this way, the cache storage device ST_C can be effectively managed to reduce the number of accessing the target storage device ST_T. In these cases, the first determination result and the second determination result may be comprises in the above-mentioned cache storage management hint AH.

In view of above-mentioned embodiments, a cache storage space managing method can be acquired. The cache storage space managing method is applied to an electronic device comprising a target storage device and a cache storage device, such as the electronic device 100 shown in FIG. 1. In one embodiment, an accessing speed of the cache storage device is higher than an accessing speed of the target storage device.

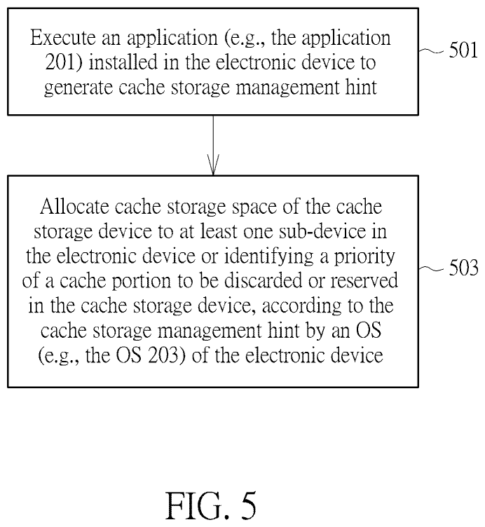

FIG. 5 is a flow chart illustrating a cache storage space managing method according to one embodiment of the present application. The cache storage space managing method comprises:

### Step 501

Execute an application (e.g., the application 201) installed in the electronic device to generate cache storage management hint.

### Step 503

Allocate cache storage space of the cache storage device to at least one sub-device in the electronic device or identifying a priority of a cache portion to be discarded or reserved in the cache storage device, according to the cache storage management hint by an OS (e.g., the OS 203) of the electronic device.

In one embodiment, the electronic device is a mobile device, and the OS is a mobile operating system. In such case, the OS may also be named as a platform. The cache storage management hint may comprise amount of cache storage space to be allocated to each one of the sub-device, or comprise conditions of task processing of the application. Also, the application may collect hardware information of the sub-device, the cache storage device or the target storage device to generate the cache storage management hint AH. Besides, the OS may collect hardware information of the sub-device, the cache storage device or the target storage device, and then allocates the cache storage space according to the hardware information and the cache storage management hint.

If the allocation policy is fixed, the performance of the electronic device 100 may not be optimized due to insufficient cache storage space. Further, if only the OS 203 can determine the allocation policy, the allocation policy may not meet real requirement since the OS 203 may not know the real requirements of the application 201. Also, in such case, the allocation policy is hard to be set by the user, since the steps of writing programs to change the OS 203 are complicated. On the opposite, the steps of writing programs to change the application 201 are easier. Accordingly, in view of above-mentioned embodiments, the allocation policy may be dynamically changed corresponding to real requirements of the app 201 in a simpler way.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A cache storage managing method, applied to an electronic device comprising a target storage device and a cache storage device for storing information which is to be accessed by the target storage device, the cache storage managing method comprising:
executing an application installed in the electronic device to generate a cache storage management hint; and
allocating cache storage space of the cache storage device to at least one sub-device in the electronic device or identifying a priority of a cache portion to be discarded or reserved in the cache storage device, according to the cache storage management hint by an operating system of the electronic device.

2. The cache storage space managing method of claim 1, wherein the cache storage management hint comprises amount of cache storage space to be allocated to each one of the sub-device.

3. The cache storage space managing method of claim 1, wherein the cache storage management hint comprises conditions of task processing of the application.

4. The cache storage space managing method of claim 1, comprising:
using a first allocation policy to allocate the cache storage space before receiving the cache storage management hint, by the operating system;
generating a second allocation policy according to the cache storage management hint after receiving the cache storage management hint, by the operating system; and
using the second allocation policy to allocate the cache storage space by the operating system.

5. The cache storage space managing method of claim 1, comprising:
collecting hardware information of the sub-device, the cache storage device or the target storage device to generate the cache storage management hint, by the application.

6. The cache storage space managing method of claim 1, comprising:
collecting hardware information of the sub-device, the cache storage device or the target storage device by the operating system; and
allocating the cache storage space according to the hardware information and the cache storage management hint by the operating system.

7. The cache storage space managing method of claim 1, wherein an accessing speed of the cache storage device is higher than an accessing speed of the target storage device.

8. The cache storage space managing method of claim 1, further comprising:
providing an API (application programming interface) to the application by the operating system, thereby the application can transmit the application hint to the operating system to control allocation of the cache storage device.

9. The cache storage space managing method of claim 1, wherein the step of identifying the priority of the cache portion to be discarded or reserved comprises:
determining which cache portion of the cache storage device is not used or will not be used to generate a first determination result;
increasing the priority of the cache portion to be discarded according to the first determination result.

10. The cache storage space managing method of claim 1, wherein the step of identifying the priority of the cache portion to be discarded or reserved comprises:
determining a usage frequency of data to generate a second determination result; and
increasing the priority of the cache portion to be reserved for the data according to the second determination result.

11. An electronic device, comprising:
a target storage device;
a cache storage device, which is configured to store information which is to be accessed by the target storage device; and
a processing circuit, configured to perform following steps:
executing an application installed in the electronic device to generate cache storage management hint; and
allocating cache storage space of the cache storage device to at least one sub-device in the electronic device or identifying a priority of a cache portion to be discarded or reserved in the cache storage device, according to the cache storage management hint by an operating system of the electronic device.

12. The electronic device of claim 11, wherein the cache storage management hint comprises amount of cache storage space to be allocated to each one of the sub-device.

13. The electronic device of claim 11, wherein the cache storage management hint comprises conditions of task processing of the application.

14. The electronic device of claim 11, wherein the processing circuit further performs:
using a first allocation policy to allocate the cache storage space before receiving the cache storage management hint, by the operating system;
generating a second allocation policy according to the cache storage management hint after receiving the cache storage management hint, by the operating system; and
using the second allocation policy to allocate the cache storage space by the operating system.

15. The electronic device of claim 11, wherein the processing circuit further performs:
collecting hardware information of the sub-device, the cache storage device or the target storage device to generate the cache storage management hint, by the application.

16. The electronic device of claim 11, wherein the processing circuit further performs:
collecting hardware information of the sub-device, the cache storage device or the target storage device by the operating system; and
allocating the cache storage space according to the hardware information and the cache storage management hint by the operating system.

17. The electronic device of claim 11, wherein an accessing speed of the cache storage device is higher than an accessing speed of the target storage device.

18. The electronic device of claim 11, wherein the processing circuit further performs:
providing an API (application programming interface) to the application by the operating system, thereby the application can transmit the application hint to the operating system to control allocation of the cache storage device.

19. The electronic device of claim 11, wherein the step of identifying the priority of the cache portion to be discarded or reserved comprises:
determining which cache portion of the cache storage device is not used or will not be used to generate a first determination result;
increasing the priority of the cache portion to be discarded according to the first determination result.

20. The electronic device of claim 11, wherein the step of identifying the priority of the cache portion to be discarded or reserved comprises:
determining a usage frequency of data to generate a second determination result; and
increasing the priority of the cache portion to be reserved for the data according to the second determination result.
